(19) United States
(12) Patent Application Publication
(10) Pub. No.: US 2022/0243846 A1
(43) Pub. Date: Aug. 4, 2022

(54) ROTATIONAL FITTING FOR LOW PURITY, HIGH PURITY, AND ULTRA HIGH PURITY GAS LINES OR PROCESS COOLING AND CRITICAL PROCESS COOLING WATER SYSTEMS

(71) Applicant: NG7 LLC, Dundee, OR (US)

(72) Inventor: Neil Severn, Dundee, OR (US)

(21) Appl. No.: 17/665,425

(22) Filed: Feb. 4, 2022

Related U.S. Application Data
(60) Provisional application No. 63/145,769, filed on Feb. 4, 2021.

(51) Int. Cl. F16L 19/025; F16L 19/02; F16L 19/00

(52) U.S. Cl. CPC F16L 19/025; F16L 19/005; F16L 19/0218

(57) ABSTRACT

A rotational high purity or ultra-high purity gas fitting or process cooling or critical process cooling water fitting comprising an inlet pipe, inlet flange, outlet flange, a compression mechanism (such as a nut and bolt mechanism), a rotational outlet pin comprising an interior flange, a sealing void, a sealing element, and an outlet pipe. The rotational high purity or ultra-high purity gas fitting or process cooling or critical process cooling water fitting provides a fitting wherein at least one end (inlet or outlet) is capable of a full 360 degree rotation clockwise or counterclockwise while maintaining a high purity and ultra-high purity gas seal or a or process cooling or critical process cooling water seal. Functional rotating ability in live and non-live systems (while gas or other medium is flowing).

### CROSS REFERENCE TO RELATED APPLICATIONS

This application claims priority to and the benefit of U.S. Provisional Patent Application No. 63/145,769, filed Feb. 4, 2021, which is incorporated by reference herein in its entirety.

### FIELD OF THE DISCLOSURE

The present disclosure is generally related to fittings for gas and water distribution systems, more specifically the present disclosure relates to rotating fittings for low purity, high purity, and ultra-high purity gas and water distribution system.

### BACKGROUND

A continuous supply of low purity (“LP”), high purity (“HP”) and ultra-high purity (“UHP”) feed gas is required in pharmaceutical manufacturing, metal production, oil & gas industries, chemical production, food & beverage, semiconductor manufacturing, analytical instrumentation, the operation of fuel cells, and other applications in which impurities in the feed gas can result in defective products, incorrect measurements, and damage to expensive equipment.

Traditional low purity, high purity, and ultra-high purity gas feed systems involve a series of gas pipes (known as gas lines) that deliver gas from a supply source, such as a gas tank, to the inlet of the production device (sometimes referred to as a tool). Thus, in a traditional installation operation, a gas line installer must weld a series of pipes and fittings to navigate a continuous gas line from a source to a destination. Additionally, gauges or other instruments for monitoring the conditions of the system may be welded to the gas line.

Process Cooling Water (“PCW”) and Critical Process Cooling Water (“CPCW”) are methods of heat removal from components and industrial equipment. These systems also require routing of pipes to specific locations to deliver cooling to heat-intensive or heat-sensitive equipment. Types of PCW and CPCW systems include: Water-to-water cooling systems that use plant water from a chiller, pond, or cooling tower to cool the process with a plate and frame heat exchanger, and Air-to-water cooling systems that use the outside air to cool the process water with radiator type cooler systems.

It is with these observations in mind, among others, that various aspects of the present disclosure were conceived and developed.

### SUMMARY

The present disclosure provides improvements over current fittings for low purity, high purity, and ultra-high purity gas lines and process cooling and critical process cooling water lines by providing a rotational fitting that makes installation and repair of such gas and water lines easier, less costly and less time consuming than the installation and repair of current fittings.

In some aspects, the techniques described herein relate to a rotational fitting, including: a first pipe having a proximal end and a distal end opposite the proximal end; a first outer flange having a proximal surface, a distal surface opposite the proximal surface, and an opening extending through a center of the first outer flange, a second outer flange having a proximal surface, a distal surface opposite the proximal surface, and an opening extending through a center of the second outer flange from the proximal surface to the distal surface, a second pipe having a proximal end and a distal end; an interior flange having a proximal end surface, a distal end surface opposite the proximal end surface and fixed to the proximal end of the second pipe, a sealing element received in the proximal end surface, and an opening extending from the proximal end surface of the second outer flange to the distal end of the second pipe, wherein the interior flange is configured to be received within a central cavity of the rotational fitting, the central cavity defined by a first recess formed by the distal surface of the first outer flange and a second recess formed by the proximal surface of the second outer flange; and a compression element configured to provide a compressive force to the first outer flange and the second outer flange to maintain a gas-tight seal between the sealing element and the distal surface of the first outer flange.

In some aspects, the techniques described herein relate to a rotational fitting, wherein the first pipe is fixed to the proximal surface of the second outer flange around the opening of the second outer flange.

In some aspects, the techniques described herein relate to a rotational fitting, wherein the first pipe and the second outer flange are formed as a single part.

In some aspects, the techniques described herein relate to a rotational fitting, wherein the first pipe and the second outer flange are formed separately and joined together.

In some aspects, the techniques described herein relate to a rotational fitting, wherein the first pipe and/or the second outer flange include stainless steel Grade-316 and Grade-316L, stainless steel Grade-304 and Grade-304L, or Brass forged with Types K, L and M copper.

In some aspects, the techniques described herein relate to a rotational fitting, wherein the proximal surface of the first outer flange is fixed to the distal end of the first pipe such that the distal end of the first pipe encircles the opening to provide a fluid connection from the distal surface of the first outer flange through the opening to the first pipe.

In some aspects, the techniques described herein relate to a rotational fitting, wherein the distal end surface of the interior flange is coupled to the proximal end of the second pipe such that the opening provides a fluid connection from the proximal end surface of the interior flange to the distal end of the second pipe.

In some aspects, the techniques described herein relate to a rotational fitting, wherein the proximal end surface of the interior flange forms a concentric sealing void configured to receive the sealing element, and wherein the sealing element is disposed at least partially within the sealing void.

In some aspects, the techniques described herein relate to a rotational fitting, wherein the sealing element is a PTFE Teflon O-ring.

In some aspects, the techniques described herein relate to a rotational fitting, wherein the distal end of the second pipe is configured to extend through the opening of the second outer flange, and wherein the second pipe is capable of full 360 degree rotation clockwise and/or counterclockwise while maintaining the gas-tight seal between the sealing element and the distal surface of the first outer flange.

In some aspects, the techniques described herein relate to a rotational fitting, wherein the compression element includes male threads formed on the distal surface of the first outer flange and female threads formed on the proximal surface of the second outer flange, wherein the male threads and the female threads are operable to provide the compressive force to the first outer flange and the second outer flange to maintain the gas-tight seal between the sealing element and the distal surface of the first outer flange.

In some aspects, the techniques described herein relate to a rotational fitting, wherein the compression element includes at least one bolt hole extending through each of the first outer flange and the second outer flange, at least one bolt, and at least one nut, wherein the at least one bolt is configured to be received through the at least one bolt hole of each of the first outer flange and the second outer flange, and wherein the at least one nut is operable to be threaded onto the at least one bolt to provide the compressive force to the first outer flange and the second outer flange to maintain the gas-tight seal between the sealing element and the distal surface of the first outer flange.

In some aspects, the techniques described herein relate to a rotational fitting, wherein the at least one nut is threaded onto the at least one bolt to provide a predetermined torque value.

In some aspects, the techniques described herein relate to a rotational fitting, wherein the compressive force is a torque value between 12 to 4000 lbf-ft.

In some aspects, the techniques described herein relate to a rotational fitting, wherein the compression element further includes at least one lock washer threaded onto the at least one bolt at a location (i) between the distal surface of the second outer flange and the at least one nut, or (ii) distal to the at least one nut.

In some aspects, the techniques described herein relate to a method for assembling a rotational fitting, including: inserting a distal end of an outlet pipe through a central opening of an annular outlet flange, wherein a proximal end of the outlet pipe is fixed to a distal end surface of an interior annular flange; receiving a distal portion of the interior annular flange within an outlet recess formed by a proximal surface of the annular outlet flange; inserting a sealing element into a concentric sealing void defined by a proximal end surface of the interior annular flange; receiving a proximal portion of the interior annular flange within an inlet recess formed by a distal surface of an annular inlet flange; and applying a compressive force to the annular inlet flange and the annular outlet flange to create and maintain a gas-tight seal between the sealing element and the distal surface of the annular inlet flange.

In some aspects, the techniques described herein relate to a method, further including: aligning at least one bolt hole of the annular outlet flange and at least one bolt hole of the annular inlet flange; inserting at least one bolt through the aligned bolt holes of the annular outlet flange and the annular inlet flange; and threading at least one nut onto a distal end of the at least one bolt and tightening the at least one nut to a selected torque.

In some aspects, the techniques described herein relate to a method, further including: threading at least one lock washer onto the distal end of the at least one bolt between a distal end surface of the annular outlet flange and the at least one nut.

In some aspects, the techniques described herein relate to a method, further including: threading at least one lock washer onto the distal end of the at least one bolt distal to the at least one nut.

In some aspects, the techniques described herein relate to a method, further including threading the at least one nut onto the at least one bolt to provide a torque force of 12 to 4000 lbf-ft.

### DESCRIPTION OF THE DRAWINGS

FIG. 1 is a perspective view of an example rotational fitting;

FIG. 2 is an exploded view of FIG. 1;

FIG. 3 is an exploded view of FIG. 1;

FIG. 4 is a cross-sectional view of the example rotational fitting of FIG. 1;

FIG. 5 is a magnified cross-sectional view of a portion of the example rotational fitting of FIG. 4;

FIG. 6 is a cross-sectional view of an example rotational outlet pin;

FIG. 7 is a flow chart describing a method of assembling the rotational low purity, high purity, and ultra-high purity gas fitting; and

### DETAILED DESCRIPTION

The present disclosure provides improvements over current fittings for low purity, high purity, and ultra-high purity gas lines and process cooling and critical process cooling water lines by providing a rotational fitting and method of assembling a rotational fitting that makes installation and repair of such gas and water lines easier, less costly and less time consuming than the installation and repair of current fittings. For example, the present disclosure provides a fitting for low purity, high purity, and ultra-high purity gas lines and process cooling and critical process cooling water lines that allows for 360 degree rotation clockwise and/or counter clockwise of an inlet or outlet pipe of the fitting. The ability to rotate the inlet or outlet pipe of the fitting makes installation and repair easier, less costly, and less time consuming because the fitting may be rotated to fit around existing piping, making installation and repair easier and decreasing the likelihood that existing piping will need to be removed to complete the job.

For the purposes of the present disclosure, there terms “inlet” and “outlet” may be referred to interchangeably, as the rotational low purity, high purity, and ultra-high purity gas fitting allows gas to flow in either direction as needed. Moreover, for the purposes of the present disclosure, it should be generally understood that “low purity, high purity, and ultra-high purity gas fitting” may also, in some embodiments, refer to a “process cooling water fitting” or a “critical process water cooling fitting.”

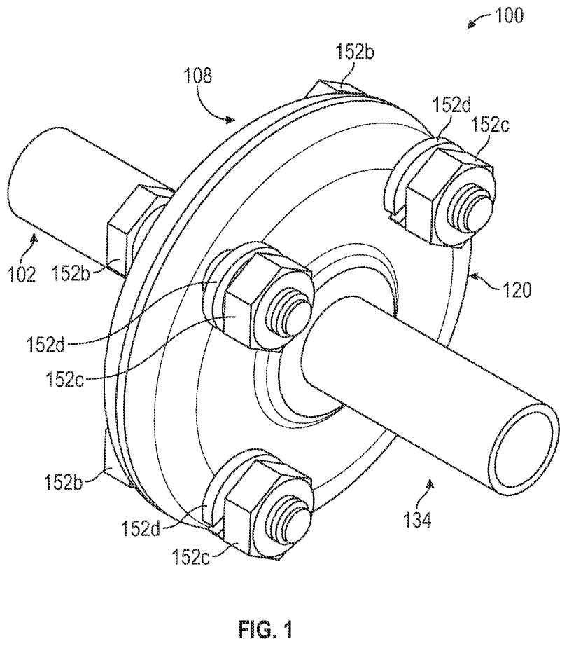

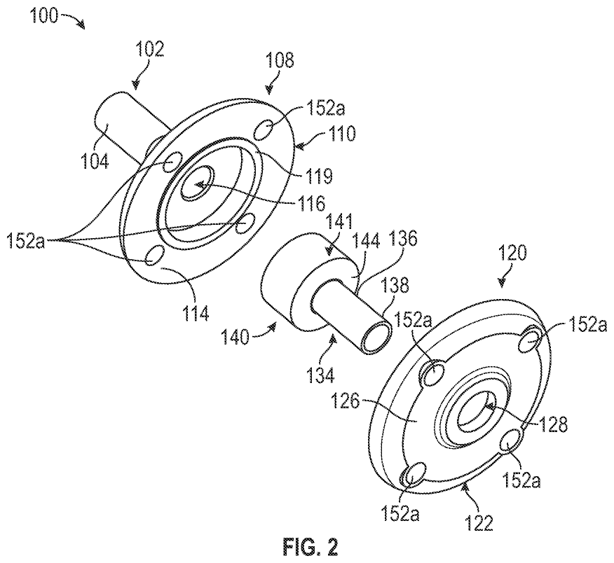

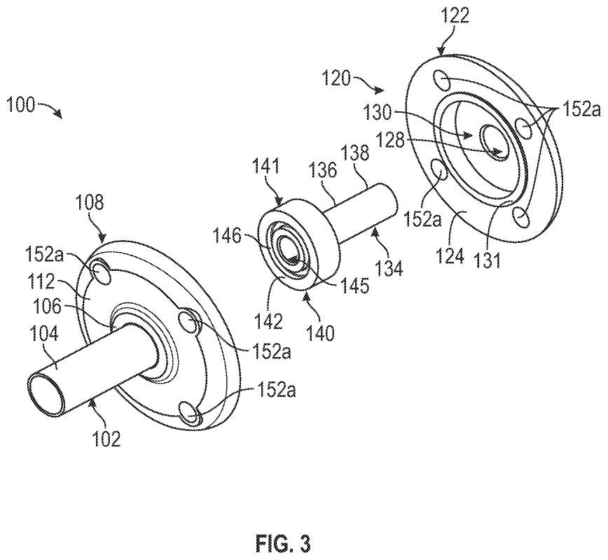

FIG. 1 is a perspective view of an example rotational fitting 100 according to some aspects of the present disclosure and FIGS. 2 and 3 are exploded views of FIG. 1 of the present disclosure. As shown in FIGS. 1-3, rotational fitting 100 may include an inlet pipe 102 having a proximal end 104 and a distal end 106. The inlet pipe 102 may be a pipe that allows gas to flow into the rotational low purity, high purity, and ultra-high purity gas fitting via an orbital weld, also known as a butt weld, to a pipe leading to a gas source (not shown). The gas source may be, for example, a pressurized gas cylinder containing a low purity, high purity, or ultra-high purity gas such as, for example Acetylene, Argon, Nitrogen, Helium, Hydrogen, Air, synthetic air (zero air), Carbon Dioxide, Oxygen, Rare gases, Pure gases, EPA Protocol Gases, Custom Gas Mixtures, etc. The gas source may also be, in some embodiments, a gaseous fuel source such as natural gas, propane, or butane. The inlet pipe 102 may provide an inlet for liquid material, such as water, gasoline, and other chemicals. The inlet pipe 102 may provide an inlet for water for PCW or CPCW system. The inlet pipe 102 may be comprised of any rigid pipe material, such as, for example, plastic, metal, steel, stainless steel, polyvinyl chloride, copper, cast iron, ductile iron, lead, aluminum, brass, cement, fiber, thermoplastic, carbon steel, reinforced concrete, nickel, allow steel, titanium, solder, polyurethan, aluminum alloy, nylon, polyvinyl fluoride, etc. The materials may be selected for HP and UHP gas applications, such as, for example stainless steel Grade-316 and Grade-316L, stainless steel Grade-304 and Grade-304L, or Brass forged with Types K, L and M copper. The inlet pipe 102 may be made from bar stock steel using a billet manufacturing process to create a low porosity pathway gas, suitable for HP and UHP gas applications. In other embodiments, inlet pipe 102 may be formed from a casting process.

The rotational fitting 100 may further include an annular inlet flange 108 (also referred to herein as an “outer flange” or “first outer flange”) operably connected to the inlet pipe 102. The inlet pipe 102 and inlet flange 108 may be formed as a single part in the same process, e.g., through a billet manufacturing process, a casting process, an additive manufacturing process such as 3D printing, etc. In other embodiments, inlet pipe 102 and inlet flange 108 may be formed separately and joined together, e.g., operatively connected through a welding or adhesion process, or some other method. The inlet pipe 102 is in a fixed position relative to inlet flange 108.

The inlet flange 198 may be comprised of any of the rigid materials previously mention as example materials for inlet pipe 102. The materials may be selected for HP and UHP gas applications, such as, for example stainless steel Grade-316 and Grade-316L, stainless steel Grade-304 and Grade-304L, or Brass forged with Types K, L and M copper.

As shown in FIGS. 2 and 3, the annular inlet flange 108 has a proximal surface 112 and a distal surface 114. The distal surface 114 forms a first recess 118 extending toward the proximal surface 112. The distal surface 114 may form a raised compression ring 119 that encircles the first recess 118. The inlet flange 108 further includes an opening 116 that extends from the distal surface 114 into the inlet pipe 102 to allow flow therethrough. The proximal surface 112 of the annular inlet flange 108 may be fixed to the distal end 106 of the inlet pipe 102 such that the distal end 106 of the inlet pipe 102 encircles the opening 116 of the inlet flange 108 to provide a fluid connection through the inlet flange 108 and the inlet pipe 102.

The rotational fitting 100 may further include an annular outlet flange 120 (also referred to herein as an “outer flange” or “second outer flange”). The outlet flange 120 has a proximal surface 124 and a distal surface 126. The proximal surface forms a second recess 130 extending toward the distal surface 126. The proximal surface 124 may form a raised compression ring 131 that encircles the second recess 130. The outlet flange 120 further includes an opening 128 that extends from the proximal surface 124 to the distal surface 126.

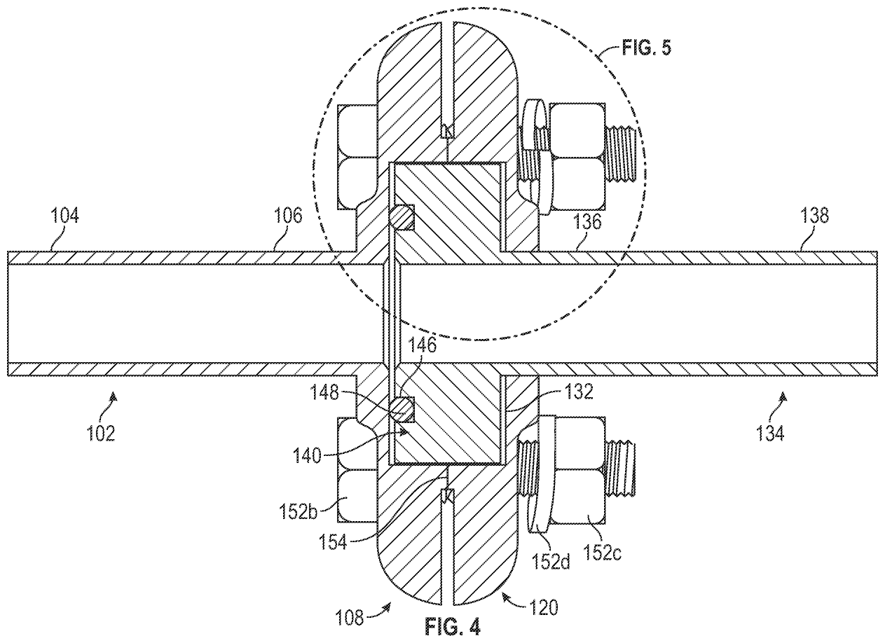

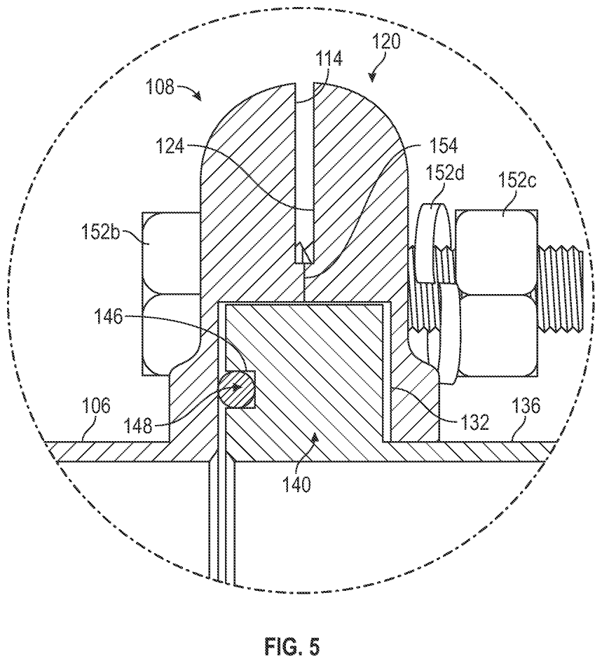

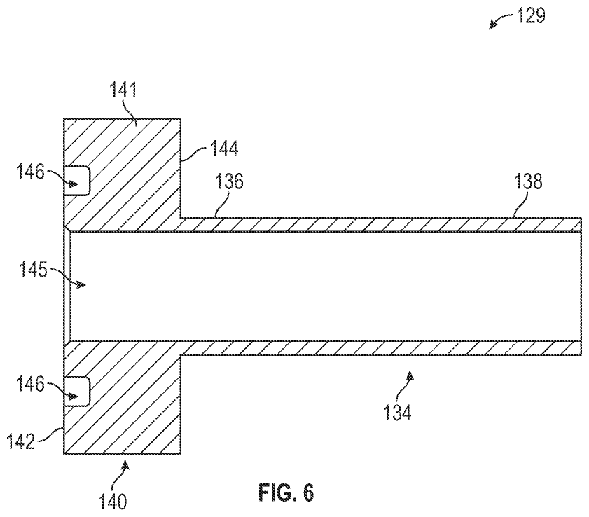

Turning to FIGS. 1-4 and 6, the rotational fitting 100 may further include a rotational outlet pin 129. FIG. 4 is a cross-sectional view of the example rotational fitting of FIG. 1, FIG. 5 is a magnified cross-sectional view of a portion of the example rotational fitting of FIG. 4, and FIG. 6 is a cross-sectional view of a rotational outlet pin, according to some aspects of the present disclosure.

The rotational outlet pin 129 includes an outlet pipe 134 having a proximal end 136 and a distal end 138. The outlet pipe 134 may be operatively connected via an orbital weld (or other connection) to any gas pipe of compatible size. The outlet pipe 134 may be operatively connected to an instrument or gauge.

The rotational outlet pin 129 may further include an interior annular flange 140 coupled to the proximal end 136 of the outlet pipe 134. The interior annular flange 140 may include a proximal surface 142 and a distal surface 144. As shown in FIGS. 4-6, the proximal surface 142 of the interior annular flange 140 may include a sealing void 146 recessed therein and configured to receive sealing element 148 (shown in FIGS. 4 and 5). The sealing element 148 may be, for example, a PTFE Teflon or Hard Viton EPDM O-ring. In some aspects, rotational outlet pin 129 includes an opening 145 extending from the proximal end surface 142 of the interior annular flange 140 to the distal end 138 of the outlet pipe 134, to allow for flow therethrough.

The interior annular flange 140 of the rotational outlet pin 129 may be configured to be received within a central void 132 (also referred to herein as a “central cavity”) of the rotational fitting 110, defined by the first recess 118 of the inlet flange 108 and the second recess 130 of the outlet flange 120, and the distal end 138 of the outlet pipe 134 may extend out of the opening 128 of the outlet flange 120.

The opening 128 of the outlet flange 120 is sized to receive the outlet pipe 134 therethrough.

The sealing element 148 recessed in the sealing void 146 on the proximal end surface 142 of the interior annular flange 140 may be configured to contact the first recess 118 in the distal surface 114 of the inlet flange 108. The sealing element may form a first seal around the opening 116 of the inlet flange 108. The first seal may encircle the opening 116 of the inlet flange 108 to provide a fluid connection from the proximal end 104 of the inlet pipe, through the rotational fitting 100, to the distal end 138 of the outlet pipe 134. The sealing void 146 may be of sufficient size to accept the sealing element 148. The sealing void 146 may be a concentric void. The sealing element 148 may be, for example, an O-ring, a gasket, Bellow seal, Cartridge seal, Labyrinth seal (A seal which creates a tortuous path for the liquid to flow through), Radial shaft seal, Axial shaft seal, caulking, Induction sealing or cap sealing, Adhesive sealant, Bodok seal, a specialized gas sealing washer, Bonded seal, also known as Dowty seal or Dowty washer (a type of washer with integral gasket, widely used to provide a seal at the entry point of a screw or bolt) Bridgman seal, a piston sealing mechanism that creates a high pressure reservoir from a lower pressure source, Bung, Compression seal fitting, Diaphragm seal, Ferrofluidic seal, Gasket or Mechanical packing seal, Flange gasket, O-ring boss seal, Piston ring, Glass-to-metal seal, Glass-ceramic-to-metal seal, Heat seal, Hose coupling, Hermetic seal, Hydrostatic seal, Hydrodynamic seal, Inflatable seal (e.g., seals that inflate and deflate in three basic directions of operation: the axial direction, the radial-in direction, and the radial-out direction. Each of these inflation directions has their own set of performance parameters for measurements such as the height of inflation and the center-line bend radius that the seal can negotiate. Inflatable seals can be used for numerous applications with difficult sealing issues.), Rotating face mechanical seal, Face seal, Wiper seal, Dry gas seal, or another type of gas or liquid seal. The sealing element 148 is an O-ring made of PTFE Teflon, Hard Viton, BUNA, BUNA(M), or some combination of materials. The sealing element 148 may be selected based on the type of gas that will flow through the rotational low purity, high purity, and ultra-high purity gas fitting. Certain gas may react, corrode, be absorbed, or otherwise interact with certain sealing element 148 materials. The selection of the sealing element 148 material may be necessary to ensure a proper long-term seal.

The rotational fitting 100 may further include a compression mechanism, defined herein as a device or system capable of providing compression between the inlet flange 108 and the outlet flange 120 to seal the rotational outlet pin 129 in the central void 132 of the rotational fitting 110. The compression mechanism may be, for example, male and female threads on the distal surface 114 (i.e., interior surface) of the inlet flange 108 and the proximal surface 124 (i.e., interior surface) of the outlet flange 120 (respectively, or the reverse), natural or artificial magnets or electromagnetics providing magnetic attraction between inlet flange 108 and outlet flange 120, or any device or system providing spring providing spring-force compression, hydraulic compression, vacuum pressure, inflatable structures, the normal force of a weighted flange, or some other method of maintaining compressive force between the inlet flange 108 and the outlet flange 120.

The compression mechanism may include at least one bolt hole 152a, at least one bolt 152b, and at least one nut 152c. For example, as shown in FIGS. 1-3, the compression mechanism includes a plurality of bolt holes 152a, a plurality of bolts 152b, a plurality of nuts 152c, and a plurality of washers 152d. The plurality of bolt holes 152a may extending through each of the inlet flange 108 and the outlet flange 124, i.e., from the proximal surface 112 to the distal surface 114 of the inlet flange 108 and from the proximal surface 124 to the distal surface 126 of the outlet flange 120.

As shown in FIGS. 1-3, the plurality of bolt holes 152a may include four bolt holes 152a arranged in a symmetrical equidistant concentric orientation around the inlet flange 108 and four bolt holes 152d in a symmetrical equidistant concentric orientation around the outlet flange 120. However, it is foreseen that any number of bolt holes 152a may be used. The bolt holes 152a of the inlet flange 108 and outlet flange 120 are configured to align when the distal surface 114 of the inlet flange 108 and the proximal surface 124 of the outlet flange 120 are aligned or brought into contact. The plurality of bolts 152b are configured to pass through the bolt holes 152a of the inlet flange 108 and the outlet flange 120 to create a bolted connection between inlet flange 108 and outlet flange 120.

Each of the plurality of bolts 152b may be secured using one of the plurality of nuts 152c at a threaded end of the respective bolt 152b. The bolts 152b pass through inlet flange 108 to create a mechanical connection to outlet flange 120 using nut 152c to secure bolt 152b in place. The nuts 152c and/or bolts 152b may be tightened to a specific torque to ensure connection between inlet flange 108 and outlet flange 120. The compression mechanism may further include at least one washer 152d. As shown in FIG. 1, the compression mechanism may a plurality of lock washers 152d. Each of the lock washers 152d may be threaded onto one of the bolts 152b, residing between the distal surface 126 (i.e., exterior surface) of the outlet flange 120 and the nut 152c. The at least one lock washer 152d may be designed to be tightened to a required torque beneath an ordinary fastener. The at least one lock washer 152d may exert a spring tension that keeps the at least one bolt 152b and at least one nut 152c from vibrating loose. The at least one lock washer 152d may be attached to the nut side of the fastener.

The at least one nut 152c may be torqued to a specific pound-foot (lbf-ft). For example, the at least one nut 152c may be torqued to 12-4000 lbf-ft. In some embodiments, the correct torque values may be based, at least in part on the size of the inlet flange 108, the size of the outlet flange 120, the size of bolt 152b, the thread distance of bolt 152b, whether the bolt 152b is lubricated or dry, the material of the sealing element 148 (shown in FIGS. 4 and 5), and/or the size of the sealing element 148, etc. In at least one example, the torque selected for nut 152c may be based, at least in part, on the size and material of sealing element 148.

As shown in FIGS. 4 and 5, the compression mechanism seals the rotational outlet pin 129 within the central void 132 of the rotational fitting 100 such that the sealing element 148 contacts the distal surface 114 (i.e., interior surface) of the inlet flange 108 around the opening 116 to the inlet pipe 102. The compression mechanism provides a compression force sufficient to create and maintain a gas-tight seal between the sealing element 148 and the distal surface 114 (i.e., interior surface) of the inlet flange 108. The torque of the compression mechanism, such as the at least one nut 152c, may be selected to ensure ideal compression of the sealing element 148. Too little compression of the sealing element 148 may cause leakage or other failures of the rotational low purity, high purity, and ultra-high purity gas fitting. Too much compression may deform or damage the sealing element 148, which may also cause leakage or other failures of the rotational low purity, high purity, and ultra-high purity gas fitting.

In some aspects, due to the compression of the sealing element 148 caused by the torque of the nuts 152c exerting force between the inlet flange 108 and the outlet flange 120, wherein the interior flange 140 is disposed between the inlet flange 108 and the outlet flange 120, the sealing element 148 thereby disposed between the distal surface 114 (interior surface) of the inlet flange 108 and the sealing void 146, the rotational outlet pipe 134 is capable of rotating 360 degree both clockwise and counterclockwise while maintaining a gas tight seal

The rotational outlet pipe 134 does not comprise a rigid connection (such as a weld) to the outlet flange 120, allowing the rotational outlet pipe 134 to complete a full 360 degree rotation both clockwise and counterclockwise while maintaining the gas-tight seal between the sealing element 148 and the distal surface 114.

The rotational outlet pipe 134 may be operatively connected via an orbital weld (or other connection) to any gas pipe of compatible size. The rotational outlet pipe 134 may connected to an angled gas pipe, allowing the angled gas pipe to be rotated 360 degree both clockwise and counterclockwise, providing flexibility of workflow and adjustment to installation or connection to other instruments or tools. Importantly, the rotational outlet pipe 134 may be rotated while HP and UHP gas is passing through, maintaining the seal throughout rotation. The rotational outlet pipe 134 may be operatively connected to an instrument or gauge, thus allowing the instrument or gauge to be rotated 360 degree clockwise or counterclockwise to provide flexible adjustments in workflow and or viewing angles of the instrument or gauge.

The rotational fitting 100 may be configured to be installed with common tools, such as a torque wrench, and may not require any specialized tools.

The inlet 102, the annular inlet flange 108, the annular outlet flange 12, and/or the rotational outlet pin 129 may be milled out of bar stock steel, in a process known as billet manufacturing. A billet is a length of metal that has a round or square cross-section, with an area less than 36 in² (230 cm²). Billets are created directly via continuous casting or extrusion or indirectly via hot rolling an ingot or bloom. Billets are further processed via profile rolling and drawing. Billet manufacturing provides low-porosity metal suitable for UHP gas applications.

The inlet 102, the annular inlet flange 108, the annular outlet flange 12, and/or the rotational outlet pin 129 may be manufactured in high volumes using metal casting. Metal casting may provide a lower cost alternative for applications for which higher porosity metals are suitable.

The inlet flange 108 and the outlet flange 120 may be comprised of cast metal, while the inlet pipe 102 and the rotational outlet pipe 134 may be comprised of bar stock, creating a pathway for HP or UHP gas while reducing cost of parts that do not come into contact with the HP or UHP gas, e.g., the inlet flange 108 and the outlet flange 120.

In some embodiments, the fixed inlet pipe 102 side of two rotational fittings 100 may be joined together, creating a joined fitting wherein both ends are fully rotational.

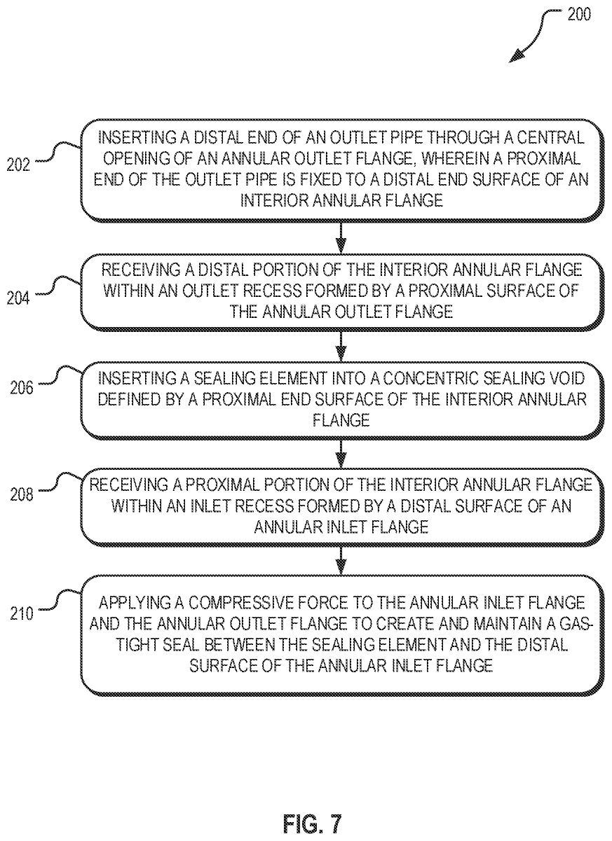

In one aspect, the present disclosure provides a method for assembling a rotational fitting 100 according to some aspects of the present disclosure. FIG. 7 is a flow chart illustrating a method 200 in accordance with aspects of the present disclosure. As shown in FIG. 7, the method 200 may include step 202 of inserting a distal end of an outlet pipe 134 through a central opening 128 of an annular outlet flange 120, wherein a proximal end 136 of the rotational outlet pipe 134 is fixed to a distal end surface 144 of an interior annular flange 140. The distal end surface 144 of the interior annular flange may be placed adjacent to a proximal surface 124 of the outlet flange 120. The method 200 may include step 204 of receiving a distal portion of the interior annular flange 140 within a recess 130 defined by the proximal surface 124 of the outlet flange 120. The method 200 may include step 206 of inserting a sealing element 148 into a concentric sealing void 146 defined by a proximal end surface 142 of the interior annular flange 140. The sealing void 146 may encircle an outlet opening 145 extending from the proximal end surface 142 of the interior annular flange 140 to the distal end of the outlet pipe 134 to provide a fluid connection from the proximal end surface 142 of the interior annular flange 140 to the distal end 138 of the outlet pipe 134. The method 200 may include aligning the proximal surface 124 of outlet flange 120 to a distal surface 114 of an inlet flange 108. The method 200 may include step 208 of receiving a proximal portion of the interior annular flange 140 within a recess 118 defined by the distal surface 114 of the inlet flange 108. The method 200 may include step 210 of applying a compressive force to the inlet flange 108 and the outlet flange 120 to create and maintain a gas-tight seal between the sealing element 148 and the distal surface 114 of the inlet flange 108.

The method 200 may include aligning at least one bolt hole 152a of the outlet flange 120 and at least one bolt hole 152a of the inlet flange 108. The method 200 may include inserting at least one bolt 152b through the aligned bolt holes 152a of the outlet flange 120 and inlet flange 108. The method 200 may include threading at least one nut 152c onto a distal end of the at least one bolt 152b and tightening the at least one nut 152c to a selected torque. The method 200 may include threading at least one lock washer 152d onto the at least one bolt 152b prior to threating the at least one nut 152c onto the at least one bolt 152b. The selected torque may be based at least in part on the size and material of sealing element 148. In one aspect, the present disclosure provides a method for disassembling a rotational fitting of the present disclosure, comprising performing the steps of the method 200 in reverse.

In one aspect, the present disclosure provides a method for creating a flexible gas line by welding a first end of the rotational low purity, high purity, and ultra-high purity gas fitting (e.g., inlet 102) according to some aspects of the present disclosure to a compatible gas pipe leading to a gas source via an orbital weld, also known as a but weld, and welding a second end of the rotational low purity, high purity, and ultra-high purity gas fitting (e.g., outlet pipe 134) to a compatible gas pipe, which may be, for example, and angled gas pipe. In such an example, the angled gas pipe may then be freely rotated into place for ease of installation, or on-the-fly modifications to the gas line, without the need to shut down the gas line. In some embodiments, two rotational low purity, high purity, and ultra-high purity gas fittings may be welded together at the inlet 102, to create a rotational low purity, high purity, and ultra-high purity gas fitting wherein both inlet and outlet are capable of a full 360 degree rotation clockwise and counterclockwise at both the inlet and outlet. In some examples, instruments or gauges may be connected to the rotational outlet pipe 134 to create a flexible instrument or gauge, capable of rotation adjustment without need to shut down the gas line or modify other components in order to adjust the position or orientation of the instrument or gauge. The rotational low purity, high purity, and ultra-high purity gas fitting may be manufactured in operable connection with an instrument, gauge, or valve, providing an instrument, gauge, or valve with the capability of 360 degree of rotation clockwise or counterclockwise.

The present disclosure provides a method of using the rotational low purity, high purity, and ultrahigh purity gas fitting in accordance with some aspects of the present disclosure in a gas line installation process. The method includes, assembling the rotational low purity, high purity, and ultra-high purity gas fitting (in some embodiments, the rotational low purity, high purity, and ultra-high purity gas fitting may arrive pre-assembled). The method includes inserting rotational outlet pipe 134 into the central void of outlet flange 120, inserting sealing element 148 into the rotational Outlet sealing void 146, aligning the interior surface of outlet flange 120 to the interior surface of inlet flange 410, aligning the bolt voids of the outlet flange 120 and inlet flange 410, and placing bolt 152b through the aligned bolt voids of the outlet flange 120 and inlet flange 410, threading lock washer 152d and nut 152c onto bolt 152b, and tightening nut 152c to a selected torque, based at least in part on the size and material of sealing element 148.

The method includes welding the inlet pipe 102 of the rotational low purity, high purity, and ultrahigh purity gas fitting 100 to a gas source. The inlet pipe 102 may be, for example, an inlet pipe that allows gas to flow into the rotational low purity, high purity, and ultra-high purity gas fitting via an orbital weld, also known as a butt weld, to a pipe leading to a gas source. The gas source may be, for example, a pressurized gas cylinder containing a low purity, high purity, or ultra-high purity gas such as, for example Acetylene, Argon, Nitrogen, Helium, Hydrogen, Air, synthetic air (zero air), Breathing Air, Carbon Dioxide, Oxygen, Rare gases, Pure gases, EPA Protocol Gases, Custom Gas Mixtures, etc. The gas source may also be, in some embodiments, a gaseous fuel source such as natural gas, propane, or butane. The inlet pipe 102 may provide an inlet for liquid material, such as water, gasoline, and other chemicals. The inlet pipe 102 may provide an inlet for water in a PCW or a CPCW system. The method includes welding the rotational outlet of the rotational low purity, high purity, and ultra-high purity gas fitting to desired fixture (gas pipe, instrument, gauge, etc.).

The rotational outlet pipe 134 creates a gas-tight seal using a sealing element 148 which maintains a seal against the interior surface of the inlet flange 108. Notably, the rotational outlet pipe 134 does not comprise a rigid connection (such as a weld) to the outlet flange 120, allowing the rotational outlet pipe 134 to complete a full 360 degree rotation both clockwise and counterclockwise while maintaining a gas-tight seal. The rotational outlet pipe 134 may be operatively connected via an orbital weld (or other connection) to any gas pipe of compatible size. The rotational outlet pipe 134 may connected to an angled gas pipe, allowing the angled gas pipe to be rotated 360 degree both clockwise and counterclockwise, providing flexibility of workflow and adjustment to installation or connection to other instruments or tools. The rotational outlet pipe 134 may be rotated while HP and UHP gas is passing through, maintaining the seal throughout rotation. In other aspects, rotational outlet pipe 134 may be operatively connected to an instrument or gauge, thus allowing the instrument or gauge to be rotated 360 degree clockwise or counterclockwise to provide flexible adjustments in workflow and or viewing angles of the instrument or gauge. The rotational low purity, high purity, and ultra-high purity gas fitting may be installed with common tools, such as a torque wrench, and may not require any specialized tools. In some embodiments, the fixed inlet pipe 102 side of two rotational low purity, high purity, and ultra-high purity gas fittings may be joined together, creating a joined fitting wherein both ends are fully rotational.

The method includes rotating fixture (gas pipe, instrument, gauge) to a desired alignment. The fixture may be rotated into place for further connection, such as may be advantageous when installing a gas line. An instrument or gauge may be rotated into alignment to increase the visibility or access to the instrument or gauge. Further, by allowing the instrument or gauge to be rotated 360 degree clockwise or counterclockwise, the rotational low purity, high purity, and ultra-high purity gas fitting provides flexible adjustments in workflow and/or viewing angles of the instrument or gauge. Finally, the method may include optionally, disconnecting/reconnecting the rotational low purity, high purity, and ultra-high purity gas fitting if needed. In some aspects, one or both ends of the rotational high purity and ultrahigh purity gas fitting may disconnected and or reconnected to allow the rotational low purity, high purity, and ultra-high purity gas fitting to be disassembled, cleaned, and, in some embodiments, allowing the sealing element 148 to be replaced or cleaned. In other aspects, neither the inlet end nor the outlet end of the rotational low purity, high purity, and ultra-high purity gas fitting need be disconnected in order to take full advantage of the rotational end of the rotational low purity, high purity, and ultra-high purity gas fitting, the connect line, instrument, or gauge, may be rotated 360 degree clockwise or counterclockwise while gas remains flowing through the rotational low purity, high purity, and ultra-high purity gas fitting.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A rotational fitting, comprising:
a first pipe having a proximal end and a distal end opposite the proximal end;
a first outer flange having a proximal surface, a distal surface opposite the proximal surface, and an opening extending through a center of the first outer flange,
a second outer flange having a proximal surface, a distal surface opposite the proximal surface, and an opening extending through a center of the second outer flange from the proximal surface to the distal surface,
a second pipe having a proximal end and a distal end;
an interior flange having a proximal end surface, a distal end surface opposite the proximal end surface and fixed to the proximal end of the second pipe, a sealing element received in the proximal end surface, and an opening extending from the proximal end surface of the second outer flange to the distal end of the second pipe, wherein the interior flange is configured to be received within a central cavity of the rotational fitting, the central cavity defined by a first recess formed by the distal surface of the first outer flange and a second recess formed by the proximal surface of the second outer flange; and
a compression element configured to provide a compressive force to the first outer flange and the second outer flange to maintain a gas-tight seal between the sealing element and the distal surface of the first outer flange.

2. The rotational fitting of claim 1, wherein the first pipe is fixed to the proximal surface of the second outer flange around the opening of the second outer flange.

3. The rotational fitting of claim 1, wherein the first pipe and the second outer flange are formed as a single part.

4. The rotational fitting of claim 1, wherein the first pipe and the second outer flange are formed separately and joined together.

5. The rotational fitting of claim 1, wherein the first pipe and/or the second outer flange comprise stainless steel Grade-316 and Grade-316L, stainless steel Grade-304 and Grade-304L, or Brass forged with Types K, L and M copper.

6. The rotational fitting of claim 1, wherein the proximal surface of the first outer flange is fixed to the distal end of the first pipe such that the distal end of the first pipe encircles the opening to provide a fluid connection from the distal surface of the first outer flange through the opening to the first pipe.

7. The rotational fitting of claim 1, wherein the distal end surface of the interior flange is coupled to the proximal end of the second pipe such that the opening provides a fluid connection from the proximal end surface of the interior flange to the distal end of the second pipe.

8. The rotational fitting of claim 1, wherein the proximal end surface of the interior flange forms a concentric sealing void configured to receive the sealing element, and wherein the sealing element is disposed at least partially within the sealing void.

9. The rotational fitting of claim 1, wherein the sealing element is a PTFE Teflon O-ring.

10. The rotational fitting of claim 1, wherein the distal end of the second pipe is configured to extend through the opening of the second outer flange, and wherein the second pipe is capable of full 360 degree rotation clockwise and/or counterclockwise while maintaining the gas-tight seal between the sealing element and the distal surface of the first outer flange.

11. The rotational fitting of claim 1, wherein the compression element includes male threads formed on the distal surface of the first outer flange and female threads formed on the proximal surface of the second outer flange, wherein the male threads and the female threads are operable to provide the compressive force to the first outer flange and the second outer flange to maintain the gas-tight seal between the sealing element and the distal surface of the first outer flange.

12. The rotational fitting of claim 1, wherein the compression element includes at least one bolt hole extending through each of the first outer flange and the second outer flange, at least one bolt, and at least one nut, wherein the at least one bolt is configured to be received through the at least one bolt hole of each of the first outer flange and the second outer flange, and wherein the at least one nut is operable to be threaded onto the at least one bolt to provide the compressive force to the first outer flange and the second outer flange to maintain the gas-tight seal between the sealing element and the distal surface of the first outer flange.

13. The rotational fitting of claim 12, wherein the at least one nut is threaded onto the at least one bolt to provide a predetermined torque value.

14. The rotational fitting of claim 10, wherein the compressive force is a torque value between 12 to 4000 lbf-ft.

15. The rotational fitting of claim 12, wherein the compression element further includes at least one lock washer threaded onto the at least one bolt at a location (i) between the distal surface of the second outer flange and the at least one nut, or (ii) distal to the at least one nut.

16. A method for assembling a rotational fitting, comprising:
inserting a distal end of an outlet pipe through a central opening of an annular outlet flange, wherein a proximal end of the outlet pipe is fixed to a distal end surface of an interior annular flange;
receiving a distal portion of the interior annular flange within an outlet recess formed by a proximal surface of the annular outlet flange;
inserting a sealing element into a concentric sealing void defined by a proximal end surface of the interior annular flange;
receiving a proximal portion of the interior annular flange within an inlet recess formed by a distal surface of an annular inlet flange; and
applying a compressive force to the annular inlet flange and the annular outlet flange to create and maintain a gas-tight seal between the sealing element and the distal surface of the annular inlet flange.

17. The method of claim 16, further comprising:
aligning at least one bolt hole of the annular outlet flange and at least one bolt hole of the annular inlet flange;
inserting at least one bolt through the aligned bolt holes of the annular outlet flange and the annular inlet flange; and
threading at least one nut onto a distal end of the at least one bolt and tightening the at least one nut to a selected torque.

18. The method of claim 17, further comprising:
threading at least one lock washer onto the distal end of the at least one bolt between a distal end surface of the annular outlet flange and the at least one nut.

19. The method of claim 17, further comprising:
threading at least one lock washer onto the distal end of the at least one bolt distal to the at least one nut.

20. The method of claim 17, further comprising threading the at least one nut onto the at least one bolt to provide a torque force of 12 to 4000 lbf-ft.
